(19) United States
(12) Patent Application Publication
(10) Pub. No.: US 2004/0145655 A1
(43) Pub. Date: Jul. 29, 2004

(54) Stereoscopic video image display apparatus and stereoscopic video signal processing circuit

(76) Inventor: Seijiro Tomita, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/724,866

(22) Filed: Dec. 2, 2003

(30) Foreign Application Priority Data
Dec. 2, 2002 (JP) 2002-349672

(51) Int. Cl. H04N 13/00

(52) U.S. Cl. 348/51; 348/42; 348/56; 348/57

(57) ABSTRACT

To provide a stereoscopic video image display apparatus in which right and left-eye video images are processed and displayed by a same signal processing circuit. A stereoscopic video image display apparatus including an image pick-up device for picking up the image of an object to be observed, display elements 90, 91 for displaying the video image which is picked up by said pick-up device and a stereoscopic video signal processing circuitry 30 for processing and converting the video signal output from said image pick-up device into a signal which can be displayed on said display device, characterized in that said image pick-up device comprises right and left-eye image pick-up elements 20 and 21 which pick up right and left-eye video images, respectively; in that said stereoscopic video signal processing circuitry comprises a video signal correction circuit 40 which alternately corrects the right and left-eye video signals and a first switch 35 for switching the right and left-eye video signals to said video signal correction circuit.

### TECHNICAL BACKGROUND OF THE INVENTION

1. Technical Field to Which the Invention Belongs

The present invention relates to a video image display apparatus and in particular to a stereoscopic video image display apparatus which displays on a plurality of display elements stereoscopic video images by using a parallax effect between right and left-eye video images which are picked up by a plurality of image pick-up elements and a stereoscopic video image processing circuit.

2. Prior Art

Prior art stereoscopic video image display apparatus (for example, binocular telescope) is deisclosed in Japanease Application Laid-Open No. hei 7-49456 in which picks up stereoscopic video images and displays them comprises two image pick-up elements (CCD cameras) and two video image display means (LCD panels). A right and left video images which are picked up by right and left pick-up elements, respectively are displayed on right and left-eye image display means, respectively.

The above-mentioned prior art stereoscopic video image display apparatus is provided with two separate right and left-eye video signal processing circuits between the image pick-up elements and the video image display means. In other words, a right-eye video image which is picked up by the right-eye image pick-up element is processed by a right-eye signal processing circuit and is then displayed on the right-eye video image display means. Simultaneously with this, the left-eye video image which is picked up by the left-eye image pick-up elements is processed by a left-eye signal processing circuit and is displayed by the left-eye video image display means.

However, due to the difference between the electrical characteristics of right and left-eye image pick-up elements, variations in the circuit characteristics of the right and left-eye signal processing circuits, and differences in circuit characteristics such as temperature characteristics, color correction, automatic gain compensation, the right-eye video image may be different from the left-eye video image so that the level of the right-eye video image signal may be different from that of the left-eye video image signal. This may result in changes in brightness and tonality of the video image signal. Such a difference between the right and left-eye video images makes it impossible for a viewer to normally view stereoscopic images in a stereoscopic manner, deteriorating the binocular effect. If differences between the picture quality and brightness of the right and left-eye video images are caused, a flicker phenomenon is then generated in association with switching between the right and left-eye video images. This may provide uncomfortable and fatigue feeling to a viewer.

An amplifying circuit, adjusting circuit, horizontal/vertical synchronization circuit, output circuit and the like are necessary for each of two image pick-up elements (CCD cameras), resulting in a large scale of circuitry, a number of circuit components and high cost for manufacturing. In particular, in an electronic binocular telescope which causes both eyes to view different video images, the picked-up video image may be recorded or stored, so that observing video images and/or recorded video images are transmitted to the other binocular telescope via communicating means. Since it is necessary to separately process two right and left-eye video images, the data having an amount which is a double of the data of a monocular display should be processed. Accordingly, an increase in circuit scale provides a serious problem. If variations in two image pick-up elements can be corrected by one circuit, the manufacturing yield can then be increased, resulting in reduction in manufacturing cost.

It is an object of the present invention to provide a stereoscopic video image display apparatus in which right and left-eye video images which are picked up by right and left-eye image pick-up elements, respectively are processed by one and same signal processing circuit and are displayed on right and left-eye display means.

### SUMMARY OF THE INVENTION

A first invention resides in a stereoscopic video image display apparatus including an image pick-up device for picking up the image of an object to be observed, a display device for displaying the video image which is picked up by said pick-up device and a stereoscopic video signal processing circuitry for processing and converting the video signal output from said image pick-up device into a signal which can be displayed on said display device, characterized in that said image pick-up device comprises right and left-eye image pick-up elements which pick up right and left-eye video images, respectively; and in that said stereoscopic video signal processing circuitry comprises a video signal correction circuit which alternately corrects the right and left-eye video signals and a first switch for alternately switching the right and left-eye video signals to said video signal correction circuit.

A second invention is characterized in the first invention in that said display device comprises a right and left-eye display elements for displaying the right and left-eye video images, respectively; and in that said stereoscopic video signal processing circuitry comprises a second switch for separating said video signal output from said video signal correction circuit into right and left-eye video signals for supplying them to said right and left-eye display elements, respectively.

A third invention is characterized in the first and second inventions in that said first and second switches switch the right and left-eye video signals in accordance with dot synchronization timing, horizontal synchronization timing or vertical synchronization timing of the video signal.

A fourth invention is characterized in the second and third inventions in that said image pick-up element picks up the video image along alternate scanning lines; in that said video signal being supplied to said video signal correction circuit via said first switch, in that said stereoscopic video signal processing circuit comprises a video combining and conversion circuit which combines a left-eye video signal output from said second switch with a left-eye video signal of previous frame along alternate scanning lines for outputting the combined video signal to said display device and combines a right-eye video signal output from said second switch with a right-eye video signal of previous frame along alternate scanning lines for outputting the combined video signal to said display device; and in that said right and left-eye display elements update and display said combined right and left-eye video signals in accordance with a predetermined timing.

A fifth invention is characterized in the first to third inventions in that said video image correction circuit comprises an amplifier having a variable gain or an attenuator having a variable attenuation, so that the difference between the levels of the right and left-eye video signals is corrected by adjusting said gain and attenuation depending upon the output level of said video signal correction circuit.

A sixth invention is characterized in the first to fourth inventions in that said video signal correction circuit includes a level shift circuit which is capable of shifting the direct current level of an input signal, so that the difference between the levels of the right and left-eye video signals is corrected by adjusting the direct current level of said input signal depending upon the direct current level of the output signal of said video signal correction circuit.

A seventh invention is characterized in the fifth or sixth inventions in that said video signal correction circuit corrects the difference between the right and left-eye video signals by correcting the pedestal levels of both video signals and/or video signal level.

A eighth invention is characterized in the first to seventh inventions that said video signal correction circuit comprises a color correction circuit which is capable of adjusting the tonality of the video signal to correct the difference between the tonality of the right and left-eye video signals.

A ninth invention is characterized in the first to eighth inventions characterized in that said stereoscopic video signal processing circuit operates to cause said first switch to pass one of the right and left-eye video signals and operates to alternately switch said second switch.

A tenth invention reside in a stereoscopic video signal processing circuitry for processing and converting right and left-eye video signals from right and left-eye image pick-up elements into a signal which can be displayed on a display device for displaying a stereoscopic video image, characterized

in that said stereoscopic video signal processing circuitry comprises a video signal correction circuit which alternately corrects the right and left-eye video signals and a first switch for alternately switching the right and left-eye video signals to said video signal correction circuit.

A eleventh invention is characterized in the tenth invention in that said stereoscopic video signal processing circuitry comprises a second switch for separating said video signal output from said video signal correction circuit into right and left-eye video signals for supplying them to said right and left-eye display elements, respectively.

A twelfth invention is characterized in the tenth and eleventh invention that said first and second switches switch the right and left-eye video signals in accordance with dot synchronization timing, horizontal synchronization timing or vertical synchronization timing of the video signal.

A thirteenth invention is characterized in the tenth to twelfth inventions in that said video image correction circuit comprises an amplifier having a variable gain or an attenuator having a variable attenuation, so that the difference between the levels of the right and left-eye video signals is corrected by adjusting said gain and attenuation depending upon the output level of said video signal correction circuit.

A fourteenth invention is characterized in the thirteenth invention characterized in that said video signal correction circuit includes a level shift circuit which is capable of shifting the direct current level of an input signal, so that the difference between the levels of the right and left-eye video signals is corrected by adjusting the direct current level of said input signal depending upon the direct current level of the output signal of said video signal correction circuit.

A fifteenth invention is characterized in the thirteenth invention in that said video signal correction circuit corrects the difference between the right and left-eye video signals by correcting the pedestal levels of both video signals and/or video signal level.

A sixteenth invention is characterized in the tenth to fifteenth inventions characterized in that said video signal correction circuit comprises a color correction circuit which is capable of adjusting the tonality of the video signal to correct the difference between the tonality of the right and left-eye video signals.

A seventeenth invention is characterized in the first to sixteenth inventions in that said stereoscopic video signal processing circuitry operates to cause said first switch to pass one of the right-eye video signal and left-eye video signals and operates to alternately switch said second switch.

### OPERATION AND ADVANTAGES OF THE INVENTION

In the present invention, a stereoscopic video image display apparatus includes an image pick-up device for picking up the image of an object to be observed, a display device for displaying the video image which is picked up by said pick-up device and a stereoscopic video signal processing circuitry for processing and converting the video signal output from said image pick\hat{ }up device into a signal which can be displayed on said display device, characterized in that said image pick-up device comprises right and left-eye image pick-up elements which pick up right and left-eye video images. Said stereoscopic video signal processing circuitry comprises a video signal correction circuit which alternately corrects the right and left-eye video signals and a first switch for switching the right and left-eye video signals to said video signal correction circuit. Since correction of variations in image pick-up elements and circuit components, temperature correction, color correction and automatic gain control (AGC) can be conducted at the same timing and by same amount for both right and left video images by combining two right and left signals into one signal and processing it by means of a single electronic circuit. Accordingly, a stereoscopic video image which causes less fatigue for viewers can be displayed without deteriorating the stereoscopic effect and causing difference between right and left video images and flickering phenomenon. Manufacturing yield of two image pick-up elements can be enhanced and the number of similar circuit components, adjustment circuits and output circuits can be reduced to one half, so that reduction in cost can be achieved. Dot clock, horizontal and vertical synchronization signals which are essential for processing of right and left separate video images can be made common, resulting in a stabilization of the signals and reduction in cost.

The amount of data of the output stereoscopic video image is made equal to that of non-stereoscopic (plain) video signal by provision of a circuit which converts right and left-eye video signals into one signal by switching in response to each horizontal or vertical synchronization signal, recording and transmission of the video signal can be conducted similarly to that of the plain video signal. This simplifies the video image display apparatus, which is advantageous in respect to reliability and cost. Semiconductor devices (video LSIs) which are same as those used for usual plain video image display can be used. The apparatus of the present invention is advantageous with respect to development period of time and cost since no development of new LSIs is required. The apparatus can be used as usual plain video camera if switching of right and left-eye video images is terminated. A video output can be obtained without any stereoscopic display.

In accordance with the present invention, the number of circuit components, adjusting circuits and output circuits for two image pick-up elements can be reduced to a half, so that its cost can be reduced. Horizontal and vertical synchronization signals which are necessary for processing of right and left video signals can be made common, so that stabilization of the signals and reduction in cost can be achieved.

### BRIEF DESCRIPTION OF THE DRAWINGS

FIG. 1 is a block diagram showing the configuration of the stereoscopic video image display apparatus which is one embodiment of the present invention;

FIG. 2 is a block diagram showing the configuration of the stereoscopic video signal processing circuit which is one embodiment of the present invention; and

FIG. 3 is a block diagram showing the configuration of the stereoscopic video image signal processing circuit which is one embodiment of the present invention.

### BEST MODE FOR CARRYING OUT THE INVENTION

Now, an embodiment of the present invention will be described with reference to the drawings.

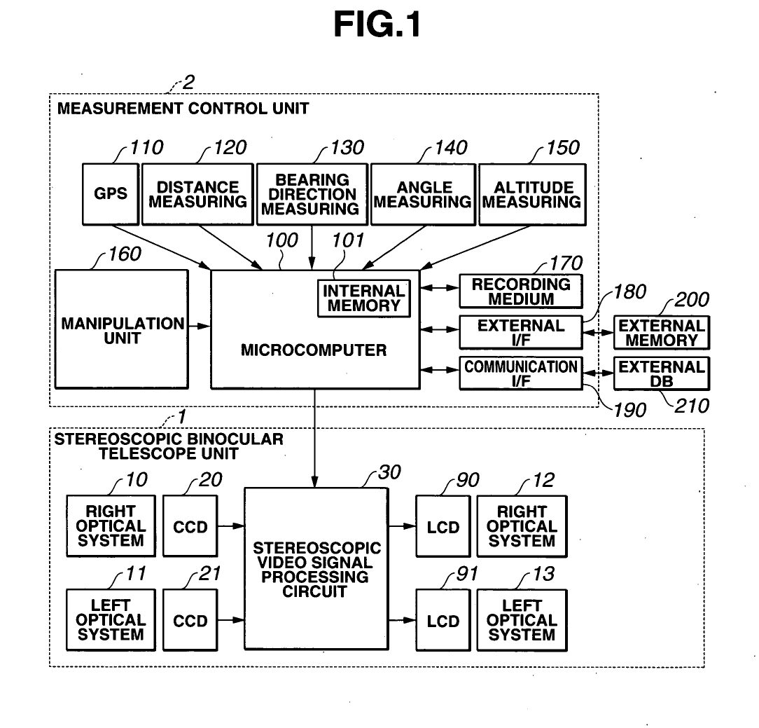

FIG. 1 is a block diagram showing the configuration of a binocular stereoscopic telescope which is one embodiment of the stereoscopic video image display apparatus of the present invention.

The stereoscopic video image display apparatus which is one embodiment of the present invention comprises a stereoscopic binocular telescope unit 1 which picks up the video image of an object to be observed for displaying the picked-up video image and a measurement control unit 2 which controls the stereoscopic binocular telescope (stereoscopic signal processing circuit 30) for generating information which is imposed on the picked-up video image for display.

The stereoscopic binocular telescope unit 1 is provided with a right optical system 10 having an optical lens and a right-eye image pick-up element (CCD) 20 for converting a video image which is captured by the right optical system 10 into an electrical signal. Similarly, the stereoscopic binocular telescope unit 1 is provided with a left optical system 11 having an optical lens and a left-eye image pick-up element (CCD) 21 for converting a video images which is captured by the left optical system 11 into an electrical signal. In other words, two optical systems and two image pick-up elements are provided, so that two video images (right and left-eye images) are simultaneously picked up.

The video signal which is generated by the right and left-eye image pick-up elements (CCDs) 20 and 21, respectively is processed by a stereoscopic video signal processing circuit 30 and is input to both right-eye display device (LCD) 90 and left-eye display device (LCD) 91. The stereoscopic video images which are displayed by right-eye display device (LCD) 90 and left-eye display device (LCD) 91 are observed by a viewer through right and left optical systems 12 and 13, respectively.

The measurement control unit 2 is provided with a control unit (microcomputer) 100 for controlling the operation of the entire of the stereoscopic video image display apparatus. The microcomputer 100 has a built-in memory (RAM) 101 therein which is used as a work area during the operation of the microcomputer 100 and temporarily stores information which will be imposed on the video signal for display.

A GPS unit 110, distance measuring unit 120, bearing angle measuring unit 130, angle measuring unit 140 and altitude measuring unit 150 are connected to the microcomputer 100. The GPS unit 110 receives radio signal from GPS satellites to obtain information on the position of the GPS unit, which is then sent to the microcomputer 100. The distance measuring unit 120 measures the distance between the unit 120 and the object to be viewed by using laser range measuring triangulation technique, so that the distance signal is sent to the microcomputer 100. The bearing angle measuring unit 130 measures the geomagnetism to determine the bearing angle, which is sent to the microcomputer 100. The angle measuring unit 140 measures the inclination angle of the stereoscopic video image display apparatus to determine the elevation angle of the object to be viewed, which is then sent to the microcomputer 100. The altitude measuring unit 150 measures the atmospheric pressure to determine the altitude above sea level of the observing point based upon the air pressure at the reference altitude and the measured pressure, so that it is sent to the microcomputer 100. The altitude above sea level may be determined by applying a geoid-altitude correction to the positional information obtained from the GPS unit.

An manipulating unit 160 is connected to the microcomputer 100. It is manipulated by the observer or viewer, so that results of the manipulation by the viewer are input to the microcomputer 100. A recording medium 170 such as flash memory, hard disk is connected to the microcomputer 100. Data which is necessary for the operation of the stereoscopic video image display apparatus is stored therein. The recording medium 170 has a video image storing area at which video images which are picked up by the stereoscopic video image display apparatus can be stored.

An external interface (external I/F) 180 is connected to the microcomputer 100, so that information can be input/output to/from an external memory connected to the stereoscopic video image display apparatus therethrough. A communication interface (communication I/F) 190 is connected to the microcomputer 100 so that video image display apparatus can communicate with external data base (external DB) 120 via a network. If a data base having map information is stored is used as the external data base 210, the necessity to store map information in the stereoscopic video image display apparatus would be then omitted, so that the storage capacity of the storage medium can be reduced.

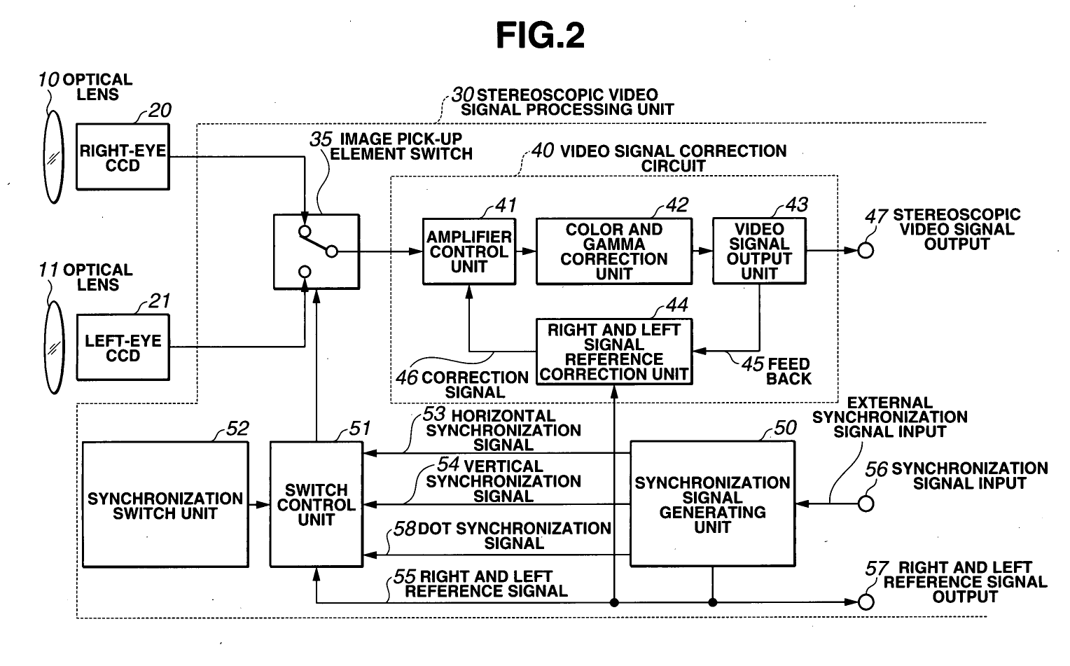

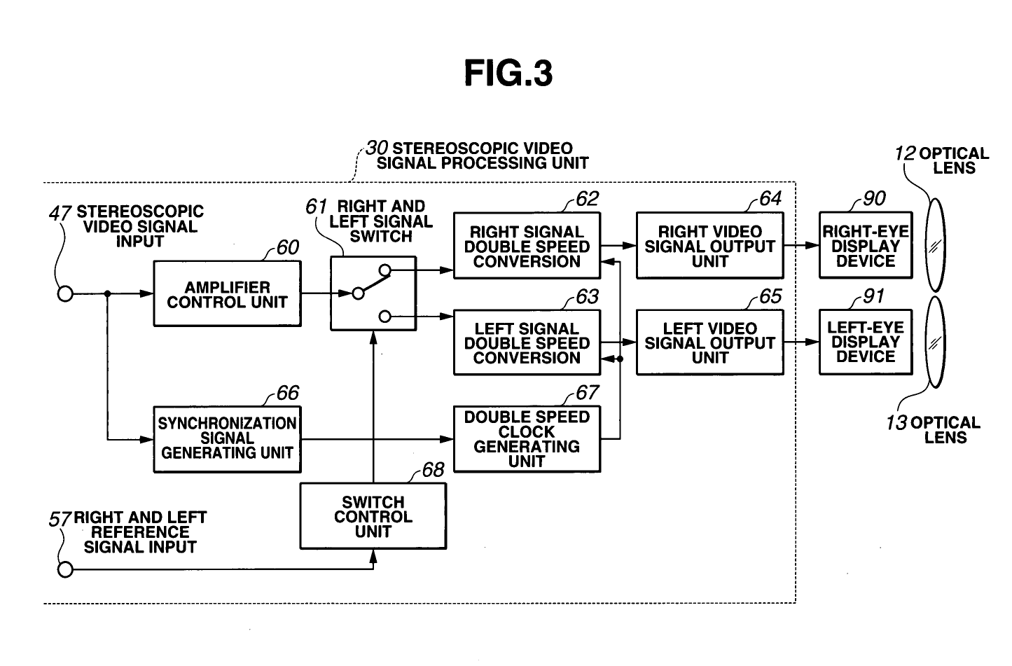

FIGS. 2 and 3 are block diagrams showing the configuration of the stereoscopic video signal processing circuit 30 which is one embodiment of the present invention. FIG. 2 is a block diagram showing the circuit configuration of the stereoscopic video signal processing circuit on the pick-up side thereof.

Both right and left-eye video signals which are generated by the right and left-eye image pick-up elements (CCDs) 20 and 21, respectively are input to the stereoscopic video signal processing circuit 30 which is one embodiment of the present invention.

The right and left-eye video signals which are input to the stereoscopic video signal processing circuit 30 are input to a pick-up element switch 35. The pick-up element switch 35 is controlled to switch between the right and left-eye video signals, so that two right and left-eye video signals are combined into one stereoscopic video signal. The combined video signal is input to amplifier control unit 41. The signal switch 35 is a switch (semiconductor switching device) which is responsive to a timing signal from a switch control unit 51. The right and left-eye video signals which are input to the amplifier control unit 41 are processed by one and same video signal correction circuit 40 (amplifier control unit 41, color and gamma correction unit 42 and video signal output unit 43).

The amplifier control unit 41 comprises an amplifier (gain variable amplifier) which is capable of changing its amplification or an attenuation variable attenuator which is capable of changing its attenuation and is adapted to adjust the level of the right and left video signals to a desired level by controlling its amplification or attenuation in response to a correction signal 46 output from the right and left signal difference correction unit 44 which will be described hereafter.

In other words, the amplifier control unit 41 has a level shift circuit and an automatic gain control capability. The pedestal level of the right and left video signals which is switched at each field unit (or each line unit or dot unit) is adjusted by the level shift circuit. The pedestal level (set-up level) is representative of the direct current reference level of the video signal which is a reference of black color level at which black color (minimum brightness) is displayed when the video signal is in the pedestal level.

100 IRE level of the right and left-eye video signals to be switched is adjusted by a variable gain amplifier (or variable attenuator). The 100 IRE level is representative of the maximum value of the video signal, which is a reference of white level at which white (maximum brightness) is displayed when the video signal is in the level of 100 IRE.

The amplifier control unit 41 adjusts the direct current level (luminance) in response to a correction signal 46 to match the luminance of the right-eye video signal with that of the left-eye video signal, so that it plays a role to eliminate flickering.

The color and gamma correction unit 42 is adapted to correct the difference between the tonality of the right and left-eye video signals by conducting color correction (or conversion of color space) and gamma correction for the right and left-eye video signals.

The video signal output unit 43 is adapted to amplify the stereoscopic video signals to such a level that they can be processed by the display side circuit (FIG. 3) of the stereoscopic video signal processing circuit 30.

The output from the video signal output unit 43 is also input to a right and left signal difference correction unit 44 as a feedback signal 45, where difference between the levels of the right and left video signals is detected from the feedback signal 45. This detection of the difference is conducted by determining based upon a right and left reference signal sent from a synchronization signal generator 50 whether the input signal is right or left video signal. The detected difference between the right and left signals is input to the amplifier control unit 40 as a correction signal 46, so that it is used for adjusting the level of the right and left video signals.

Correction conditions for the right and left-eye video signals are separately stored in the right and left signal difference correction unit 44. The correction conditions are preliminarily determined based upon the differences between the electrical characteristics of the right and left-eye image pick-up element 20 and 21 and are stored. Such correction of the difference between the electrical characteristics of the right and left-eye image pick-up elements 20 and 21 by the right and left signal difference correction unit 44 increases the manufacturing yield, reducing the manufacturing cost.

The right and left reference signal 55 instructs the image pick-up element switch 35 and the right and left signal switch 61 to switch the right and left video signals and discriminates whether the video signal is right or left signal when the stereoscopic video signal are displayed or transmitted as a general signal. In response to the right and left reference signal 55, the switch control unit 51 controls information for instructing the switching of the right and left video signals in synchronization with switch timing signal. The right and left reference signal 55 is output from the right and left reference signal output 57 and is used for discriminating whether the stereoscopic video signal output from the stereoscopic video signal output 47 is right-eye video signal or left-eye video signal.

The switch control unit 51 is adapted to control the operation of the image pick-up element switch 35 in response to a horizontal synchronization signal 53, vertical synchronization signal 54 and right and left reference signal 55 which is input thereto from the synchronization signal generator 50. The switch control unit 51 switches a signal input to the video signal correction circuit 40 (amplifier control unit 41 and the like) for each field of the video signal (for example, 16.6833 m seconds which is a period of vertical synchronization of NTSC format) or for each line (scanning line) (for example, 3.5555 seconds which is a period of horizontal synchronization of NTSC format). In other words, the switch control unit 51 presets the timing of the switching of the right and left-eye video signals which is conducted by the image pick-up element switch 35.

The switch timing of the above-mentioned image pick-up switch 35 is preset by the synchronization switch 52. In other words, the synchronization switch 52 instructs the switch control unit 51 to select between the switching of the right and left-eye video signals for each field in synchronization with the vertical synchronization timing, switching of the right and left-eye video signals for every line in synchronization with the horizontal synchronization timing and dot synchronization for switching right and left-eye video signals for every display element.

The synchronization signal generating unit 50 generates the horizontal synchronization signal 53, vertical synchronization signal 54 and right and left reference signal 55 in response to the video synchronization signal 56, input from a circuit (for example, display controller) external of the stereoscopic video signal correction circuit 40. The right and left reference signals 55 are input to the switch control unit 51 as well as the right and left signal switch 61 os the display side circuit.

Although an example in which the video signal correction circuit 40 is made of analog circuits has been described, the circuit 40 may be formed of digital circuits. In other words, an A/D converter may be provided at a stage subsequent to the image pick-up element switch 35, so that color and gamma correction is digitally conducted for outputting the amplified (level-adjusted) digital video signal). In case of digital processing of the video signal, the apparatus may be configured as follows: The image pick-up switch 35 is not operated in response to the right and left reference signal 55. A header of the digitalized video signal may include information which makes it possible to discriminate whether the video signal is right or left-eye video signal and information for delimiting the fields of the video signal. The image pick-up element switch 35 extracts this information contained in the header to switch between the right and left-eye video signals based upon header information so that the switched video signals is supplied to the video signal correction circuit 40.

FIG. 3 shows the circuit configuration of the display stage of the stereoscopic video signal processing circuit 30.

The stereoscopic video signal 47 which is processed and output by the video signal correction circuit 40 is input to the amplifier control unit 60 and is converted into a signal having such a level that it is suitable for processing in the display stage circuit. The stereoscopic video signal is input to the right and left signal switch 61, so that the switch separates the signals into the right and left-eye video signals which have been processed via the same circuit. The right and left signal switch 61 is a switch (semiconductor switching element) which is operated in response to a timing signal from the switch control unit 68.

Switching of the right and left video signal is controlled by the switch control unit 68. The right and left reference signal 55 which is generated by the synchronization signal generating unit 50 is input to the switch control unit 68 via the right and left reference signal input/output 57. The right and left signal switch 61 is controlled in response to the reference signal. In other words, the switch control unit 68 delays the right and left video signals by a period of time corresponding to processing time at the video signal correction circuit 40 and amplifier control unit 60 with respect to the switch timing of the image pick-up switch 35 to switch the right and left video signals for separating them.

The right and left video signals which are separated by the right and left signal switch 61 are input to a right and left signal double speed conversion units 62 and 63, respectively. A double speed clock signal which is generated by a double speed clock generating unit 67 is input to the right and left signal double speed conversion units 62 and 63 so that the right and left video signals which have been processed at a speed which is a double of the usual field synchronization speed (or line synchronization speed) are converted into video signals having a speed corresponding to usual field synchronization (or line synchronization) speed.

Specifically, the right and left-eye image pick-up elements 20 and 21 output video data on alternate scanning lines at intervals of 1/60 seconds. In synchronization with this, the image pick-up element switch 35 switches an input signal to the video signal correction circuit 40 at intervals of 1/120 seconds. The right and left signal switch 61 at the output stage switches the destination of the output at intervals of 1/120 seconds to send the video signal to the right or left signal double speed conversion unit 62 and 63. The right and left signal double speed conversion unit 62 and 63, respectively have video signal frame memories for temporarily storing right and left video signals which are sent at intervals of 1/60 seconds. The right signal double speed conversion unit 62 reads out at next interval of 1/60 seconds the right-eye video signal which was stored in the video signal frame memory at preceding interval to combine two right-eye video signals for sending them to the right-eye video signal output unit 64. The combined right-eye video image is updated at a period of 1/60 seconds and is displayed on the right-eye display device 90. Similarly, the left signal double speed conversion unit 63 reads out at next interval of 1/60 the left-eye video signal which was stored in the video signal frame memory at previous interval to combine two left-eye video signals for sending the combined left-eye video signal to the left-eye video signal output unit 64. The combined left-eye video image is updated at intervals of 1/60 seconds and is displayed on the left-eye display device 90.

The image pick-up element picks up the video image along every one scanning line at a predetermined timing (at intervals of 1/60 seconds). The right signal double speed conversion unit 62 combines a right-eye video signal output from the right and left signal switch 61 with the right-eye video signal of previous frame along alternate scanning lines to output it for displaying it on the right-eye display element. The left signal double speed conversion unit 63 combines the left-eye video signal output from the right and left signal switch 61 with the left-eye video signal of the previous frame alternate scanning lines o output it to the left-eye display element 91. The right eye display element 90 updates and displays the combined right-eye video signal (information on all scanning lines) at said predetermined timing (at intervals of 1/60 seconds). The left-eye display element 91 updates and displays the combined left-eye video signal (information on all scanning lines) at said predetermined timing (at intervals of 1/60 seconds).

The double speed clock signals which are input to the right and left signal double speed conversion units 62 and 64 are generated by the synchronization signal generating unit 66 and double speed clock generating unit 77. The stereoscopic video signal 47 which was processed by the video signal correction circuit 40 is input to the synchronization signal generating unit 66, which extracts the timing of field, line or dot from the stereoscopic video signal 47. One of field synchronization timing, line timing and dot timing is to be extracted is determined by the synchronization switch 52. In case of vertical synchronization, the field synchronization timing is extracted as vertical synchronization signal. In case of horizontal synchronization, line synchronization is extracted as horizontal synchronization signal. In case of dot synchronization, display timing of each display element (dot) is extracted as dot synchronization signal.

The timing signal which is extracted in the synchronization signal generating unit 66 is converted into a signal having a double frequency by the double speed clock generating unit 67 and is supplied to the right and left signal conversion unit 62 and 63.

The right video signal which is converted by the right signal double speed conversion unit 62 is supplied to the right video signal output unit 64. The right video signal output unit 64 comprises a liquid crystal driver and converts the right video signal into a signal which can be displayed on the right-eye display device (LCD panel) 90 supplying it to the right-eye display device 90. The left video signal which is converted by the left signal double speed conversion unit 63 is supplied to the left video signal output unit 65. The left video signal output unit 65 comprises a liquid crystal driver and converts the left video signal into a signal which can be displayed on the left-eye display device (LCD panel) 91 for supplying it to the left-eye display device 91.

Then, the viewer or observer views the right and left-eye video images which are displayed on the right and left-eye display device 90 and 91 through optical means (lenses) 12 and 13, respectively.

Operation in which the stereoscopic video image display apparatus of the present invention is used as a monocular display apparatus will be described.

In case in which the stereoscopic video image apparatus is used as a monocular display apparatus, the video signal which is generated by the right and left-eye pick-up element 21 is right and left-eye display device 90 and 91, respectively. Specifically, the pick-up element switch 35 switches the video signal which is picked up by the right or left-eye pick-up element 20 or 21 to the video signal correction circuit 40. The right and left signal switch 61 is switched in a predetermined timing (for example, vertical synchronization timing) to supply the video signal to right and left-eye display device 90 and 91, so that same video image is displayed on the right and left-eye display device 90 and 91.

Alternatively, unlike an example in which the right-eye display device 90 is separated from the left-eye display device 91, only one display device which is capable of displaying right and left-eye video images maybe provided, so that the displayed right and left-eye video images can be independently incident upon the right and left eyes of the viewer by means of optical means. For example, as is described in JP-A-Tokkai Hei 10-63199, a polarization filter which transmits differently polarized light for each horizontal line of a liquid crystal panel. Differently polarized light is incident in different direction to the liquid crystal display panel from the rear thereof, so that right and left-eye video images are incident upon the right and left eyes of the viewer.

1. A stereoscopic video image display apparatus including an image pick-up device for picking up the image of an object to be observed, a display device for displaying the video image which is picked up by said pick-up device and a stereoscopic video signal processing circuitry for processing and converting the video signal output from said image pick-up device into a signal which can be displayed on said display device, characterized in that said image pick-up device comprises right and left-eye image pick-up elements which pick up right and left-eye video images, respectively; and
in that said stereoscopic video signal processing circuitry comprises a video signal correction circuit which alternately corrects the right and left-eye video signals and a first switch for alternately switching the right and left-eye video signals to said video signal correction circuit.

2. A stereoscopic video image display apparatus as defined in claim 1 characterized in that said display device comprises a right and left-eye display elements for displaying the right and left-eye video images, respectively; and in that said stereoscopic video signal processing circuitry comprises a second switch for separating said video signal output from said video signal correction circuit into right and left-eye video signals for supplying them to said right and left-eye display elements, respectively.

3. A stereoscopic video image display apparatus as defined in claim 2, characterized in that said first and second switches switch the right and left-eye video signals in accordance with dot synchronization timing, horizontal synchronization timing or vertical synchronization timing of the video signal.

4. A stereoscopic video image display apparatus as defined in claim 2 or 3, characterized in that said image pick-up element picks up the video image along alternate scanning lines;
in that said video signal being supplied to said video signal correction circuit via said first switch,
in that said stereoscopic video signal processing circuit comprises a video combining and conversion circuit which combines a left-eye video signal output from said second switch with a left-eye video signal of previous frame along alternate scanning lines for outputting the combined video signal to said display device and combines a right-eye video signal output from said second switch with a right-eye video signal of previous frame along alternate scanning lines for outputting the combined video signal to said display device; and
in that said right and left-eye display elements update and display said combined right and left-eye video signals in accordance with a predetermined timing.

5. A stereoscopic video image display apparatus as defined in any one of claims 1 to 4, characterized in that said video image correction circuit comprises an amplifier having a variable gain or an attenuator having a variable attenuation, so that the difference between the levels of the right and left-eye video signals is corrected by adjusting said gain and attenuation depending upon the output level of said video signal correction circuit.

6. A stereoscopic video image display apparatus as defined in any one of claims 1 to 4, characterized in that said video signal correction circuit includes a level shift circuit which is capable of shifting the direct current level of an input signal, so that the difference between the levels of the right and left-eye video signals is corrected by adjusting the direct current level of said input signal depending upon the direct current level of the output signal of said video signal correction circuit.

7. A stereoscopic video image display apparatus as defined in claim 5 or 6 characterized in that said video signal correction circuit corrects the difference between the right and left-eye video signals by correcting the pedestal levels of both video signals and/or video signal level.

8. A stereoscopic video image display apparatus as defined in any one of claims 1 to 7, characterized in that said video signal correction circuit comprises a color correction circuit which is capable of adjusting the tonality of the video signal to correct the difference between the tonality of the right and left-eye video signals.

9. A stereoscopic video signal processing apparatus as defined in any one of claims 1 to 8, characterized in that said stereoscopic video signal processing circuit operates to cause said first switch to pass one of the right and left-eye video signals and operates to alternately switch said second switch.

10. A stereoscopic video signal processing circuitry for processing and converting right and left-eye video signals from right and left-eye image pick-up elements into a signal which can be displayed on a display device for displaying a stereoscopic video image, characterized
in that said stereoscopic video signal processing circuitry comprises a video signal correction circuit which alternately corrects the right and left-eye video signals and a first switch for alternately switching the right and left-eye video signals to said video signal correction circuit.

11. A stereoscopic video signal processing circuitry as defined in claim 10 characterized in that said stereoscopic video signal processing circuitry comprises a second switch for separating said video signal output from said video signal correction circuit into right and left-eye video signals for supplying them to said right and left-eye display elements, respectively.

12. A stereoscopic video signal processing circuitry as defined in claim 2, characterized in that said first and second switches switch the right and left-eye video signals in accordance with dot synchronization timing, horizontal synchronization timing or vertical synchronization timing of the video signal.

13. A stereoscopic video signal processing circuitry as defined in any one of claims 10 to 12, characterized in that said video image correction circuit comprises an amplifier having a variable gain or an attenuator having a variable attenuation, so that the difference between the levels of the right and left-eye video signals is corrected by adjusting said gain and attenuation depending upon the output level of said video signal correction circuit.

14. A stereoscopic video signal processing circuitry as defined in any one of claims 10 to 12, characterized in that said video signal correction circuit includes a level shift circuit which is capable of shifting the direct current level of an input signal, so that the difference between the levels of the right and left-eye video signals is corrected by adjusting the direct current level of said input signal depending upon the direct current level of the output signal of said video signal correction circuit.

15. A stereoscopic video signal processing circuitry as defined in claim 13 or 14 characterized in that said video signal correction circuit corrects the difference between the right and left-eye video signals by correcting the pedestal levels of both video signals and/or video signal level.

16. A stereoscopic video signal processing circuitry as defined in any one of claims 10 to 15, characterized in that said video signal correction circuit comprises a color correction circuit which is capable of adjusting the tonality of the video signal to correct the difference between the tonality of the right and left-eye video signals.

17. A stereoscopic video signal processing circuitry as defined in any one of claims 10 to 16, characterized in that said stereoscopic video signal processing circuitry operates to cause said first switch to pass one of the right-eye video signal and left-eye video signals and operates to alternately switch said second switch.
